(19) United States
(12) Patent Application Publication
(10) Pub. No.: US 2004/0237783 A1
(43) Pub. Date: Dec. 2, 2004

(54) Process to separate solids from a solids laden gaseous feed stream

(76) Inventors: Martin John Hawkins Borley, Amsterdam (NL); Hubertus Wilhelmus Albertus Dries, Amsterdam (NL)

Correspondence Address: Charles W Stewart, Shell Oil Company, Intellectual Property, P O Box 2463, Houston, TX, 77252-2463, US

(21) Appl. No.: 10/492,244

(22) PCT Filed: Oct. 10, 2002
(86) PCT No.: PCT/EP02/11375

(51) Int. Cl. B01D 45/12

(52) U.S. Cl. 95/271

(57) ABSTRACT

A process to separate solids from a solids laden gaseous feed stream having a solids part and a gaseous part by means of a cyclone separator provided with a tangentially positioned feed inlet and a tubular gas outlet conduit protruding a tubular cyclone housing from above, wherein at the external surface of the tubular gas outlet conduit and inside the tubular cyclone housing a secondary gas is provided having a lower density than the density of the gaseous part of the feed stream being solids free.

The invention is directed to a process to separate solids from a solids laden gaseous feed stream comprising a solids part and a gaseous part by means of a cyclone separator provided with a tangentially positioned feed inlet and a tubular gas outlet conduit protruding a tubular cyclone housing from above wherein at the external surface of the tubular gas outlet conduit and inside the tubular cyclone housing a secondary gas is provided.

A tangential inlet cyclone is well known and for example described in Perry's Chemical Engineers' handbook, 5^{th} edition, 1973, McGraw-Hill Inc., pages 20-83 to 20-85.

When the solids in the gaseous flow contains fouling components, for example tar, moisture, coke precursors, cohesive particulates or fly-ash, optionally in combination with small (catalyst) particles, it has been found that such particles might deposit and in time a layer of said fouling components can grow on the outside of the gas outlet conduit. In time this layer will negatively influence the separation efficiency of the cyclone. Furthermore parts of the layer can come free from the surface and fall down into the lower end of the cyclone and obstruct for example the flow of particles through the cyclone bottom-opening and dipleg. Typical processes wherein such solids laden gasses are fed to tangential cyclones as described above are fluid catalytic cracking (FCC) processes, coal gasification processes, direct reduction of iron ore processes and coking processes. The present invention aims at avoiding that such fouling can occur on the external surface of the gas outlet conduit of said cyclone separators.

U.S. Pat. No. 5,376,339 describes a cyclone separator to separate the FCC catalysts from the effluent of a FCC reactor riser. In addition to this riser effluent a mixture of steam, FCC catalyst particles and hydrocarbon vapour is supplied to a position near the top end of the external surface of the tubular gas outlet conduit and inside the tubular cyclone housing. This secondary mixture is the vapour effluent of the steam stripper of said FCC unit.

WO-A-9809730 describes a cyclone separator to separate the FCC catalysts from the effluent of a FCC reactor riser, wherein around the gas outlet an inlet is provided for solids-laden gas to enter the cyclone housing from above. This inlet is provided with swirl imparting means. This secondary mixture is the vapour effluent of the steam stripper of said FCC unit.

U.S. Pat. No. 5,362,379 describes a cyclone separator provided with an open lower end to separate the FCC catalysts from the effluent of a FCC reactor riser. As in the above cited disclosures an inlet is provided around the gas outlet of the cyclone for gas to enter the cyclone housing from above. This secondary mixture is the vapour effluent of the steam stripper of said FCC unit.

In an article of G. Staudinger and Hoffmann, VDI Berichte, Nr. 1290, 1996 pages 127-139 a laboratory cyclone element for separation of solids laden gasses is described, wherein to the tangential cyclone a secondary gas was supplied at a position near the top end of the external surface of the tubular gas outlet conduit and inside the tubular cyclone housing. The secondary gas had the same composition as the gaseous part of the solids laden gas. It was found that adding such a secondary gas at the disclosed position the separation efficiency was, if at all, slightly positively influenced.

U.S. Pat. No. 4,043,899 discloses a cyclone separator to separate the FCC catalysts from the effluent of a FCC reactor riser. To this cyclone steam is supplied to the lower end of the cyclone tubular body to effect a cyclonic stripping of catalysts separated from the reactor effluent.

The present invention aims at avoiding fouling of the external surface of the gas outlet conduit of the tangential cyclone separators.

The following process achieves this object. Process to separate solids from a solids laden gaseous feed stream comprising a solids part and a gaseous part by means of a cyclone separator provided with a tangentially positioned feed inlet and a tubular gas outlet conduit protruding a tubular cyclone housing from above, wherein at the external surface of the tubular gas outlet conduit and inside the tubular cyclone housing a secondary gas is provided having a lower density than the density of the gaseous part of the feed stream being solids free.

Applicants have shown that by using as secondary gas a gas having a substantially lower density as the density of the gaseous part of the solids laden gas a sort of protective gas layer will form around the gas outlet tube. Because no components will pass this protective layer due to the centrifugal forces acting on this relatively light gas and because of the fact that the secondary gas does not comprise such potentially sticky components no fouling components will contact the external surface of the gas outlet conduit and no fouling will occur.

The process of the invention is different from the processes as previously disclosed in U.S. Pat. No. 5,376,339, WO-A-9809730 and U.S. Pat. No. 5,362,379 because in these processes the secondary gas contains amounts of FCC catalyst particles and hydrocarbon vapours. Because these compounds are present fouling can still occur when said processes are used. The present process is different from the process as disclosed in U.S. Pat. No. 4,043,899 because the steam added to the cyclone will not result in the protective layer as described above because the steam is provided at a position far away from the gas outlet conduit.

The density of the secondary gas is preferably at most 50% and more preferably at most 30% of the density of the gaseous part of the feed stream. The secondary gas is preferably chosen from the group of gasses, which are also part of the gaseous part of the solids laden gas. Examples of suitable gasses which are typically part of the feeds to said cyclone in the earlier referred to processes are methane, ethane, nitrogen, steam or mixtures of two or more of said gasses. In an FCC process the secondary gas may advantageously be a light gas fraction comprising methane and components having similar boiling points or lower as obtained in the product recovery train of said FCC process. Steam is also advantageously used because adding steam will not result in major downstream capacity problems in the FCC recovery train. The secondary gas will not contain any detectable amount of solids or coke precursors.

The amount of secondary gas as supplied to said cyclone is preferably below 10 vol %, more preferably between 1-5 vol % and most preferably between 1-3 vol % of the gaseous part of the solids laden feed supplied to said cyclone.

The location at which the secondary gas is provided may be at any position such that the protective layer around the gas outlet conduit is formed. Preferably the secondary gas is provided at the upper end of the gas outlet conduit, for example through a sleeve between the gas outlet tube and the cover closing the upper end of the tubular cyclone housing. Another preferred embodiment is when the secondary gas is provided via a number of openings present in a hollow wall of the tubular gas outlet conduit.

The tangential cyclone may be provided with a dipleg as for example shown in U.S. Pat. No. 5,376,339 or without a dipleg as for example shown in U$-A-5569435 or U.S. Pat. No. 5,362,379.

The solids laden gaseous feed is preferably the effluent of a FCC reactor riser.

1. A process to separate solids from a solids laden gaseous feed stream comprising a solids part and a gaseous part by means of a cyclone separator provided with a tangentially positioned feed inlet and a tubular gas outlet conduit protruding a tubular cyclone housing from above, wherein at the external surface of the tubular gas outlet conduit and inside the tubular cyclone housing a secondary gas is provided having a lower density than the density of the gaseous part of the feed stream being solids free.

2. The process of claim 1, wherein the density of the secondary gas is at most 50% of the density of the gaseous part of the feed stream.

3. The process of claim 2, wherein the density of the secondary gas is at most 30% of the density of the gaseous part of the feed stream.

4. The process of claim 3, wherein the secondary gas is steam.

5. The process claims 1-4, wherein the secondary gas is provided at the upper end of the gas outlet conduit.

6. The process of claims 1-4, wherein the secondary gas is provided via a number of openings present in a hollow wall of the tubular gas outlet conduit.

7. The process of claims 1-6, wherein the secondary gas does not contain coke precursors, particulates and/or solids that may cause fouling on surfaces at which the turbulence is low.

8. The process of claim 2, wherein the secondary gas is provided at the upper end of the gas outlet conduit.

9. The process of claim 3, wherein the secondary gas is provided at the upper end of the gas outlet conduit.

10. The process of claim 4, wherein the secondary gas is provided at the upper end of the gas outlet conduit.

11. The process of claim 2, wherein the secondary gas is provided via a number of openings present in a hollow wall of the tubular gas outlet conduit.

12. The process of claim 3, wherein the secondary gas is provided via a number of openings present in a hollow wall of the tubular gas outlet conduit.

13. The process of claim 4, wherein the secondary gas is provided via a number of openings present in a hollow wall of the tubular gas outlet conduit.

14. The process of claim 2, wherein the secondary gas does not contain coke precursors, particulates and/or solids that may cause fouling on surfaces at which the turbulence is low.

15. The process of claim 3, wherein the secondary gas does not contain coke precursors, particulates and/or solids that may cause fouling on surfaces at which the turbulence is low.

16. The process of claim 4, wherein the secondary gas does not contain coke precursors, particulates and/or solids that may cause fouling on surfaces at which the turbulence is low.

17. The process of claim 5, wherein the secondary gas does not contain coke precursors, particulates and/or solids that may cause fouling on surfaces at which the turbulence is low.

18. The process of claim 6, wherein the secondary gas does not contain coke precursors, particulates and/or solids that may cause fouling on surfaces at which the turbulence is low.
